(19) United States
(12) Patent Application Publication
(10) Pub. No.: US 2020/0064277 A1
(43) Pub. Date: Feb. 27, 2020

(54) METHOD OF DETECTING DEFECTS IN WORK PIECES HAVING CURVED OR CYLINDRICAL SURFACES

(71) Applicant: GM Global Technology Operations LLC, Detroit, MI (US)

(72) Inventor: Scott A. Hucker, Ortonville, MI (US)

(21) Appl. No.: 16/112,056

(22) Filed: Aug. 24, 2018

(51) Int. Cl. G01N 21/952; G01N 21/88; G01N 21/95; G06T 3/40; G06T 7/00; H04N 5/225; G06T 7/32

(52) U.S. Cl. CPC G01N 21/952; G01N 21/8851; G01N 21/9515; G06T 3/4038; G06T 7/0004; G06T 2207/20221; G06T 7/32; G01N 2201/062; G01N 2201/10; G06T 2207/30164; G06T 2207/10016; H04N 5/2256

(57) ABSTRACT

A method of detecting defects in workpieces having curved or cylindrical surfaces such as shafts, crankshafts, camshafts, bearings and the like by illuminating the curved or cylindrical surfaces of the workpiece, rotating the workpiece and the curved or cylindrical surfaces about their common axis, recording a plurality of adjacent individual longitudinal elongate images representing discrete circumferentially adjacent, axially extending regions of the curved or cylindrical surfaces of the workpiece, assembling these recorded discrete circumferentially adjacent images into a continuous, coherent planar image, detecting surface irregularities in the continuous, planar image and determining whether such detected irregularities are of a magnitude sufficient to reject the workpiece.

### FIELD

The present disclosure relates to a method of detecting defects in workpieces having curved or cylindrical surfaces such as shafts, crankshafts, camshafts, bearings and the like and more particularly to a method of detecting defects in workpieces having curved or cylindrical surfaces such as shafts, crankshafts, camshafts, bearings and the like by capturing a plurality of individual adjacent images representing discrete adjacent, circumferential regions of the curved or cylindrical surface of the workpiece, assembling these images into a continuous, coherent planar image, detecting surface irregularities and determining whether such detected irregularities are of a magnitude sufficient to reject the workpiece.

### BACKGROUND

The statements in this section merely provide background information related to the present disclosure and may or may not constitute prior art.

A significant portion of the manufacture of automotive and motor vehicle components is devoted to both devising manufacturing processes that ensure accurate mass produced components and developing post-fabrication testing and examining protocols for detecting the occasional defect.

Planar, i.e., two dimensional, vision and photographic techniques have long been utilized to detect irregularities in medical images and defects in components such as sealing surfaces in engine blocks. Components having cylindrical surfaces such as prop shafts, crankshafts, camshafts, bearings, and clutch and transmission components present both an added layer of defect detection difficulty and the need for an enhanced level of detection accuracy. This is so because (a) conventional planar detection techniques are essentially unusable with regard to cylindrical components and curved surfaces and (b) they are subjected to constant stress during vehicle operation and are therefore especially critical powertrain components.

Accordingly, it is quite common to individually examine each engine crankshaft or other component after fabrication to check for visible scratches, porosity, surface visible inclusions and any other fabrication defects that would compromise its desired function and expected extended service life.

Such examination is routinely performed by skilled quality control personnel whose only job is to accept or reject a finished crankshaft or other component. This step is, however, time consuming and an inspection method incorporating enhanced speed and consistency would therefore be desirable.

### SUMMARY

The present disclosure provides a method of detecting defects in workpieces having curved or cylindrical surfaces such as shafts, crankshafts, camshafts, bearings and the like by uniformly illuminating the curved or cylindrical surface of the workpiece, rotating the curved workpiece about an appropriate axis, recording a plurality of adjacent individual longitudinal elongate images representing discrete circumferentially adjacent, axially extending regions of the curved or cylindrical surface of the workpiece, optionally correlating these images to align them axially, assembling these recorded discrete circumferentially adjacent images into a continuous, coherent planar image, detecting surface irregularities in these images and determining whether such detected irregularities are of a magnitude sufficient to reject the workpiece.

Thus it is an aspect of the present disclosure to provide an improved method of detecting defects in workpieces having curved or cylindrical surfaces such as shafts, crankshafts, camshafts, bearings and the like.

It is a further aspect of the present disclosure to provide an improved method of detecting defects in work pieces having curved or cylindrical surfaces such as shafts, crankshafts, camshafts, bearings and the like while uniformly illuminating the workpiece.

It is a still further aspect of the present disclosure to provide an improved method of detecting defects in work pieces having curved or cylindrical surfaces such as shafts, crankshafts, camshafts, bearings and the like by uniformly illuminating the curved workpiece and recording (capturing) a plurality of individual elongate (strip) adjacent images representing discrete, circumferentially adjacent, axially extending regions of the surface of the workpiece,

It is a still further aspect of the present disclosure to provide an improved method of detecting defects in work pieces having curved or cylindrical surfaces such as shafts, crankshafts, camshafts, bearings and the like by uniformly illuminating the curved workpiece, recording a plurality of individual elongate (strip) adjacent images representing discrete, circumferentially adjacent, axially extending regions of the surface of the workpiece and assembling these recorded discrete, circumferentially adjacent images into a continuous, coherent planar image.

It is a still further aspect of the present disclosure to provide an improved method of detecting defects in work pieces having curved or cylindrical surfaces such as shafts, crankshafts, camshafts, bearings and the like by uniformly illuminating the curved workpiece, recording a plurality of individual elongate (strip) adjacent images representing discrete circumferentially adjacent, axially extending regions of the surface of the workpiece, assembling these recorded discrete, circumferentially adjacent images into a continuous, coherent planar image and detecting surface irregularities in these images.

It is a still further aspect of the present disclosure to provide an improved method of detecting defects in work pieces having curved or cylindrical surfaces such as shafts, crankshafts, camshafts, bearings and the like by uniformly illuminating the curved workpiece, recording a plurality of individual elongate (strip) adjacent images representing discrete, circumferentially adjacent, axially extending regions of the surface of the workpiece, assembling these recorded discrete, circumferentially adjacent images into a continuous, coherent planar image and detecting surface irregularities in these images and determining whether such detected irregularities are of a magnitude sufficient to reject the workpiece.

Further aspects, advantages and areas of applicability will become apparent from the description provided herein. It should be understood that the description and specific examples are intended for purposes of illustration only and are not intended to limit the scope of the present disclosure in any way.

### DRAWINGS

The drawings described herein are for illustration purposes only and are not intended to limit the scope of the present disclosure in any way.

FIG. 1 is a plan view of a work piece such as an engine crankshaft in place on an inspection fixture which embodies the present method and includes light sources, electronic imaging cameras and a drive assembly;

FIG. 2 is a side elevational view of an electronic camera and light source utilized by the present method;

FIG. 3 is a perspective view of a workpiece and electronic image field of an electronic camera according to the present method;

FIG. 4 is a diagrammatic view of a microprocessor, computation and memory module which facilitates practice of the present method;

FIG. 5 is a schematic view of a microprocessor which facilitates practice of the present method;

FIG. 6 is a flow chart of the sequence of steps of the present method to inspect components having curved or cylindrical surfaces;

FIG. 7 is a pictorial representation of a sequence of images captured by an electronic camera of a curved or cylindrical feature of a shaft such as a crankshaft; and

FIG. 8 is a pictorial representation of the sequence of images of FIG. 5 that have been stitched together to form a planar image of a curved or cylindrical feature of a shaft such as a crankshaft.

### DETAILED DESCRIPTION

The following description is merely exemplary in nature and is not intended to limit the present disclosure, application, or uses.

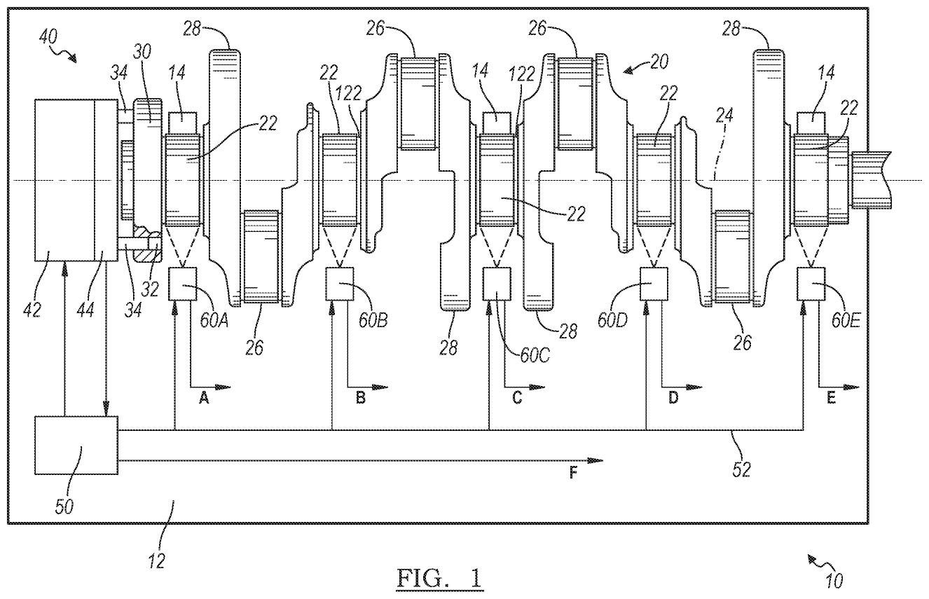

With reference now to FIG. 1, in inspection fixture or jig which embodies and facilitates practice of the present method is illustrated and generally designated by the reference number 10. The inspection fixture 10 includes a rigid base 12 which includes a plurality of spaced-apart vertical supports or stanchions 14 which engage and rotatably support a typically elongate component or workpiece 20. Preferably, the supports 14 include curved surfaces (not illustrated) which extend over at least 135° and define a curvature complementary to the curved or cylindrical surfaces of the workpiece 20 they will engage. The workpiece 20 illustrated is an engine crankshaft having a plurality of axially spaced apart main bearing journals 22 which are all coaxial to a center reference axis 24. It will be appreciated that the workpiece (crankshaft) 20 is merely illustrative and that the present method may be utilized with a wide assortment of shafts, camshafts, and similar mechanical components having as few as one cylindrical surface or journal or many such surfaces spaced along its length. The workpiece (crankshaft) 20 has been utilized as an example herein because it is a complex engine component which generally requires inspection and such inspection embodies all aspects of the present method.

The workpiece (crankshaft) 20 also includes a plurality of eccentric crank pin journals 26 which each receive a connecting rod (not illustrated) and may include counter weights 28. It will be appreciated that the surfaces of the crank pin journals 26 may also be inspected by the present method.

At one end of the component or workpiece (crankshaft) 20 is a flange 30 to which is typically bolted an engine flywheel (not illustrated) when the crankshaft 22 is installed and assembled into an internal combustion engine (also not illustrated). The flange 30 includes a plurality of through openings 32 which may conveniently be engaged by a complementarily arranged plurality of drive pins 34 during the inspection process which extend from a drive assembly 40 mounted to the base 12. The drive assembly 40 includes a source of motive power 42 which may be either a conventional motor and speed reducer having an output speed of approximately 30 r.p.m. or a stepping motor capable of a similar rotational speed.

The output of the motive power source 42 rotates the workpiece 20 and is coupled to a rotation sensor 44 which provides a signal to a drive assembly control module 50 to indicate the rotational speed and position of the workpiece 20. It will be appreciated that the exact nature of the drive assembly 40 will depend upon the object undergoing inspection. The drive assembly control module 50 provides data in a line 52 to the electronic cameras 60 described below and in a line F regarding speed and position of the workpiece 20 to facilitate synchronizing recording or capture of electronic images.

It will be appreciated that the above-recited rotational speed may be increased to 40 or 50 r.p.m. and above, for example, for smaller diameter work pieces 20 or those requiring less stringent inspection and that the above-recited rotational speed may be reduced to 20 or 10 r.p.m. and below, for example, for larger diameter work pieces 20 or those requiring more stringent inspection.

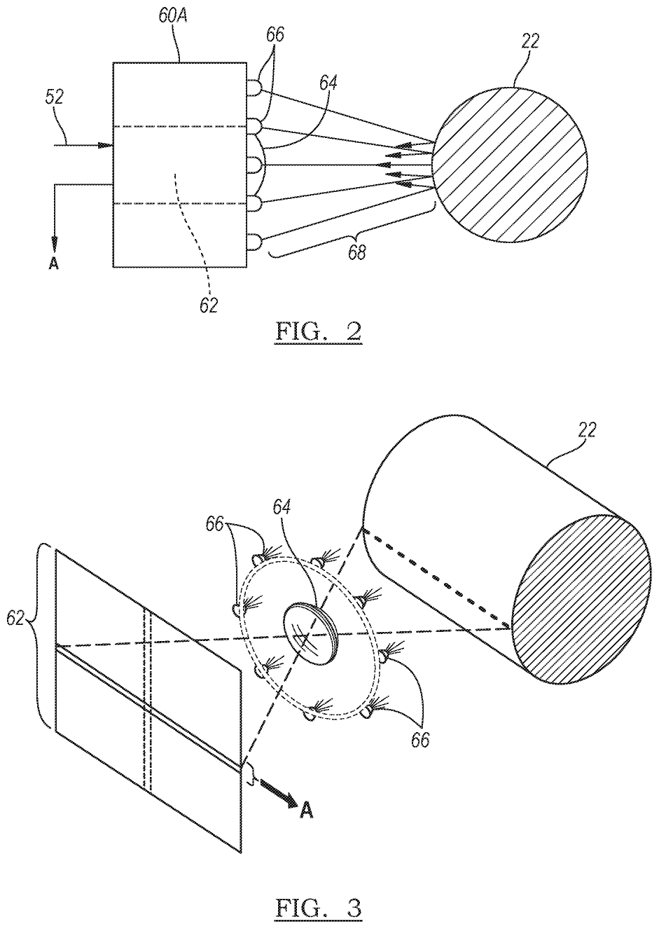

Referring now to FIGS. 1 and 2, at each longitudinal (axial) location of the journal bearings 22 along the crankshaft 20 to be inspected is disposed an electronic imaging camera 60 which is secured to the base 12. Inasmuch as the workpiece (crankshaft) 20 includes five main bearing journals 22, each receives a dedicated electronic imaging camera, 60A, 60B, 60C, 60D and 60E. The cameras 60A, 60B, 60C, 60D and 60E are identical and thus only the first camera 60A is illustrated in FIGS. 2 and 3 and described here in detail, it being understood that this description applies with equal accuracy to the other four cameras. Each of the cameras 60A, 60B, 60C, 60D and 60E includes a high resolution electronic imaging field 62, having an array of rows and columns of pixels, which is controlled (activated) by the signal from the drive assembly control module 50 and has an electronic image output in one of the associated lines A, B, C, D and E. Each of the cameras 60A, 60B, 60C, 60D and 60E also includes a short focus lens 64.

With regard to inspection of eccentric crank pin journals 26, these may also be inspected by the presently disclosed method with an additional step of either maintaining the electronic imaging cameras 60 at a fixed distance from the surface of the crank pin journals 26, by, for example a servo-mechanism, while the workpiece 20 is rotated in order to maintain proper focus on the journals 26 or rotating a crank pin journal 26 about its axis before a fixed position camera 60 as illustrated in FIG. 1.

It should be understood that if the available inspection cycle time is short, multiple cameras may be utilized on an individual journal bearing 22. For example, if the inspection cycle time is constrained to one half the preferred workpiece 20 rotation time, two cameras 60 arranged in diametric opposition may be utilized on each journal bearing 22.

Surrounding the lens 64 of each of the cameras 60A, 60B, 60C, 60D and 60E is a ring of a plurality of lights 66, preferably LED's. By “ring of lights” is meant a substantially continuous path, or loop of lights 66 which is not necessarily circular but which surrounds the lens 64 and provides uniform, consistent and substantially shadowless light to the features of the workpiece 20 that are being inspected, such as the main journal bearings 22. The paths of light which are designated 68 in FIG. 2 illustrate how the light is generally concentrated on the axial region of the journal bearing 22 directly opposite the camera lens 64 such that a smooth (acceptable) surface reflects significant light to the camera lens 64 whereas a defect such as porosity or a surface inclusion will reflect less light and appear as a dark spot or region. Such significant contrast between the desirable, smooth surface of the journal bearing 22 and the shapes or patterns of dark areas of a defect facilitates detection thereof as described subsequently.

Referring now to FIGS. 2 and 3, because the desired image of the workpiece 20 such as a journal bearing 22 is highly elongate, only the data from a small number of the rows of pixels of the electronic imaging field 62 of each of the cameras 60A, 60B, 60C, 60D and 60E will be recorded and utilized. In the preferred, landscape orientation of the camera 60A, the rows of recorded and utilized pixels are represented by the two horizontal lines. (Should the camera 60A be in portrait orientation, the recorded and utilized columns of pixels are represented by the two dashed lines.)

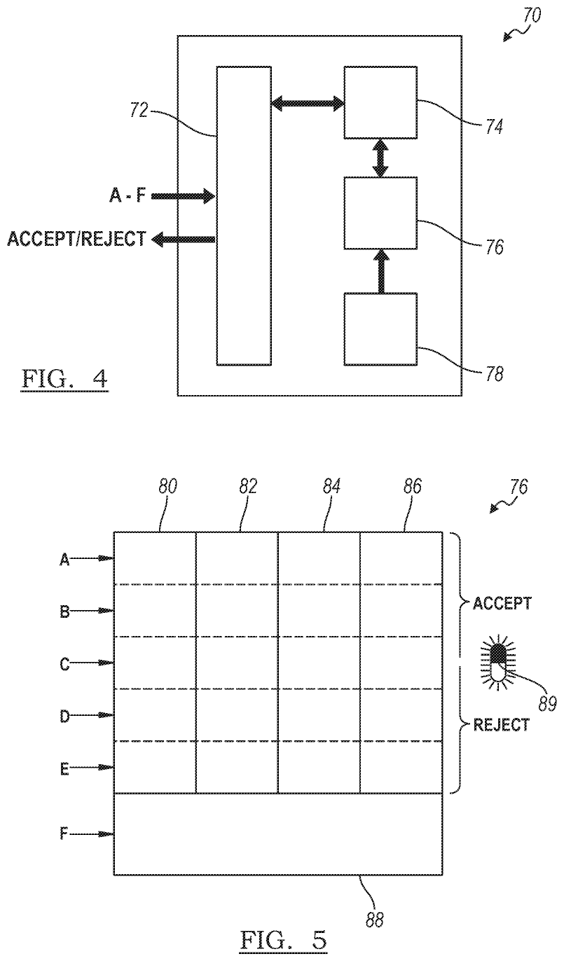

Referring now to FIG. 4, a diagrammatic view of a microprocessor, computation and memory module 70 which includes various electronic data input and output devices, volatile and fixed, i.e., transitory and non-transitory computer readable memories used to store data, control logic, software applications, instructions, computer code and lookup tables and processors is illustrated. Specifically, the module 70 includes an input and output data buffer and conditioner 72, a transient or volatile (erasable and active) memory 74 and a microprocessor 76 for manipulating data according to instructions stored in a fixed, read only memory or storage device 78 for the software, programs, subroutines and algorithms which perform the steps of the inspection method 90 described below.

Referring now to FIG. 5, the microprocessor 76 is illustrated schematically and includes a plurality of electronic devices having programs, software, applications or subroutines for receiving, storing, manipulating and outputting data from the cameras 60A, 60B, 60C, 60D and 60E including individual, dedicated transient memories 80 for the images (data) from each of the cameras 60A, 60B, 60C, 60D and 60E, a dedicated auto-correlation and image stitching module 82 for manipulating the images (data) from each of the cameras 60A, 60B, 60C, 60D and 60E, a defect detection module 84 for each of the assembled images (data) from the module 82, and a comparative accept/reject module 86 which determines whether a workpiece 20 will be accepted or rejected and, finally, an annunciator 89 which provides visible or audible notification of the decision to accept or reject the workpiece 20. The microprocessor 76 also includes a synchronizing executive module 88 which receives data or signals in the line F such as synchronizing and timing signals and start and stop commands which are utilized by the microprocessor 76 to synchronize and coordinate the various processing steps.

It should be appreciated and understood that the microprocessor 76, schematically illustrated in FIG. 5, includes the above-recited, elements or modules 80, 82, 84, 86 and 88 which include individual sections or segments that are dedicated to and associated with each of the individual cameras 60A, 60B, 60C, 60D and 60E. This isolation and dedication is indicated by the horizontal, dashed lines in FIG. 5. Thus, first of all, each of the journal bearings 22 of the workpiece 20 is independently inspected and undergoes an associated independent determination of acceptability. Second of all, the plurality of elements or modules 80, 82, 84, 86 and 88 may be reduced to single elements or modules if the workpiece 20 includes only a single curved or cylindrical surface or journal bearing 22 or increased, essentially without limit, in the case of a workpiece 20 having a large number of curved or cylindrical surfaces or journal bearings 22. The function and thus the nature of these elements or modules 80, 82, 84, 86 and 88 of the microprocessor 76 will be described in greater detail below, in connection with the specific steps of a method of inspection 90.

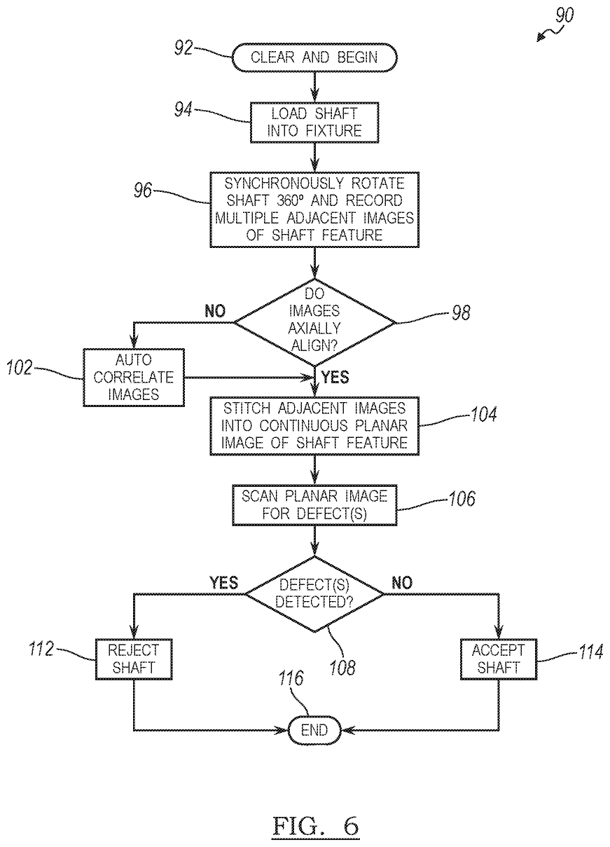

Referring now to FIGS. 1 and 6, the steps of the present method 90 which are executed by the elements or modules 80, 82, 84, 86 and 88 of the microprocessor 76 are set forth in a flow chart. An initialization step 92 which clears certain previously stored data and readies the transient memories 80 to receive image data begins the method 90. Either before or after the step 92, a component or workpiece 20, such as a shaft, crankshaft or camshaft is loaded into the supports 14 of the fixture 10 and coupled to the drive assembly 40 in a process step 94. As noted above, such features as the openings 32 of a flywheel flange 30 on the workpiece (crankshaft) 22 facilitate ready and convenient coupling to the drive pins 34 of the drive assembly 40.

In a step 96, a start signal is generated, preferably by the drive assembly control module 50 and provided to both the source of motive power 42 and in the line F to the synchronizing executive module 88 of the microprocessor 76 and specifically to the transient memories 80 for each of the cameras 60A, 60B, 60C, 60D and 60E. If desired, the drive assembly control module 50 may also provide a command to provide electrical power to the LED's 66 associated with each of the cameras 60A, 60B, 60C, 60D and 60E. The drive assembly control module 50 receives feedback data from the rotation sensor 44 which is utilized to relate (synchronize) rotation of the workpiece 20 with the repetition (imaging) rate of the cameras 60A, 60B, 60C, 60D and 60E. Additionally, the rotation sensor 44 provides data to the drive assembly control module 50 so that the workpiece 20 is rotated 360° (or less if full inspection of the perimeter is not required) while the images are being recorded.

While it will be appreciated that rotational and image recording speeds may vary widely depending upon the resolution, image accuracy and thus the level of defect detection required, a numerical example will assist the understanding by one skilled in the art of automated component or workpiece inspection. A typical and exemplary crankshaft journal 22 may have an axial length of approximately 25 mm. (0.98 in.) and a diameter of 50 mm. (1.97 in.), thus defining a circumference of approximately 157 mm. (6.18 in.). In order to achieve the necessary level of defect detection, namely detection of a defect having a size between approximately 0.05 mm. to 0.25 mm. (0.002 in. to 0.01 in.) or greater, a longitudinal scan (image) along the surface of the journal 22 having a height of approximately 0.025 mm. to 0.1 mm. (0.001 in. to 0.004 in.) has been found to be desirable. With the crankshaft journal bearing 22 described above, this circumferential scan will result in the recordation of approximately 1500 or more images. Preferably, rotation of the workpiece 20 through 360° and capture of these 1500 images can be accomplished in approximately 2 seconds. Workpieces 20 having larger diameter cylindrical surfaces will generally take correspondingly longer to capture a correspondingly larger number of images and vice versa.

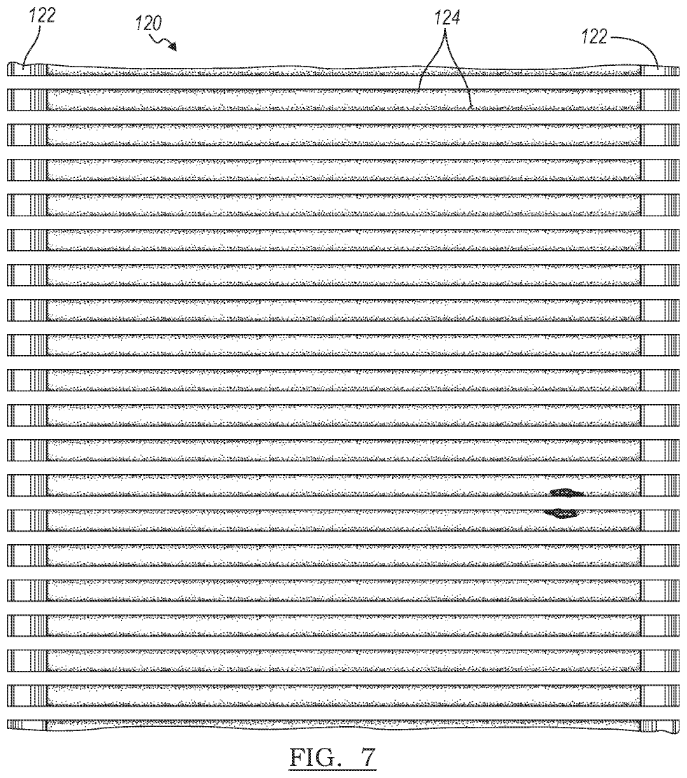

A portion of these recorded images are illustrated pictorially in FIG. 7. and designated by the reference number 120. Note, first of all, that the images 120 include undercuts 122 at each end of the journals 22 as illustrated in FIG. 1 and, second of all, that in each of the images 120, the brightest area is that elongate region in the horizontal middle of the image 120, directly opposite the camera lens 64, and that the shading (stippling) 124, the density of which has been exaggerated for purposes of explanation, pictorially represents slightly reduced brightness toward the upper and lower edges of the images 120.

As illustrated in FIG. 3, because of the highly elongate nature of the images 120 of the journals 22 recorded by the cameras 60A, 60B, 60C, 60D and 60E, and, depending upon the orientation of the cameras 60A, 60B, 60C, 60D and 60E (either landscape, with the long dimension of the images 120 oriented horizontally, which is the preferred orientation, or portrait, with the long dimension oriented vertically, relative to the work piece 20, only the pixels in a small number of rows (in landscape orientation) or a small number of columns (in portrait orientation) at the center of the image field of the cameras 60A, 60B, 60C, 60D and 60E will be utilized and transmit data to the transient memory 80 of the microprocessor 76.

In the next method step, a decision point 98 which is performed by the auto-correlation and image stitching portion or module 82 of the microprocessor 76, inquiry is made as to whether the serial, plural images 120 align axially. In general, this alignment and combination of elongate images 120 is aided by linear surfaces that may or may not be of interest in the defect analysis, yet are physically present, such as the journal/fillet edge in a crankshaft or the lobe edge of a camshaft. In this example, this interrogation is facilitated by the recording of the undercuts 122 at each end of the journals 22 and in the resulting images 120. If they do align axially, the decision point 98 is exited at YES and the method moves to a process step 104. If the images 120 do not axially align, the decision point 98 is exited at NO and an auto-correlation process step 102 is undertaken to axially align the recorded images 120 so that the undercuts 122 and all the other recorded features of the journal 22 in the images 120 are in proper axial alignment. It should be understood that the decision point 98 and the auto-correlation process step 102 are optional as many images 120 will be constrained or otherwise limited axially so that they will inherently align and obviate such axial auto-correlation.

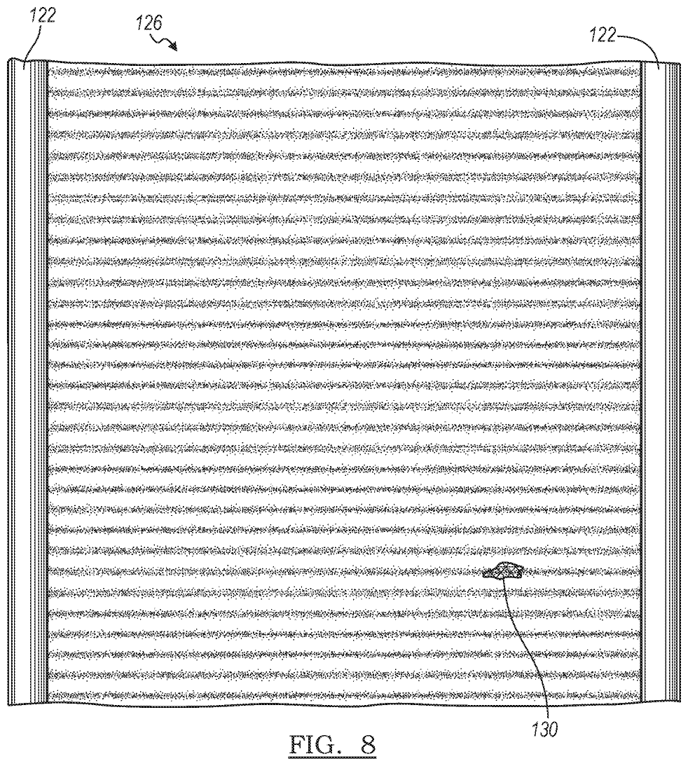

In the process step 104, the adjacent images 120, illustrated in FIG. 7, are electronically stitched together to form the uninterrupted, planar electronic image 126 illustrated in FIG. 8. Such electronic stitching may be readily and conveniently accomplished by a program such as Adobe® Photoshop®. Adobe and Photoshop are registered trademarks of Adobe Systems, Inc. The planar image 126 is then electronically scanned in a process step 106 for defects such as porosity and surface visible inclusions which typically manifest themselves as dark areas 130 in the planar image 126, as stated above.

Finally, a decision point 108 is encountered. If dark areas 130 are detected as a defect in a scan of the planar image 126 in the process step 106 by the appropriate analysis method encoded in the software contained in the comparative accept/reject module 86, the decision point 108 is exited at YES and an indication is provided by the annunciator 89 to an operator or associated equipment (both not illustrated) that the work piece (crankshaft) 20 should be rejected. If no defects are detected, the decision point 108 is exited at NO and an indication is provided by the annunciator 89 to an operator or associated equipment that the work piece (crankshaft) 20 should be accepted. The method 90 is then complete and it stops at an end point 116.

The present description is merely exemplary and illustrative in nature and variations that do not depart from the gist of the disclosure are intended to be, and should be considered to be, within the scope of the present disclosure. Such variations are not to be regarded as a departure from the spirit and scope of the disclosure.

What is claimed is:

1. A method of inspecting components having curved or cylindrical surfaces, comprising the steps of:
providing a workpiece having at least one cylindrical surface defining a center axis,
connecting a drive motor and rotation sensor to the workpiece,
providing an electronic imaging camera,
providing a light source to illuminate a portion of the cylindrical surface,
synchronously rotating the workpiece and recording a sequence of electronic images of the illuminated cylindrical surface,
stitching together the sequence of electronic images to create an electronic planar image of the cylindrical surface, and
determining whether a defect exists in the cylindrical surface of the workpiece.

2. The method of inspecting components of claim 1 wherein the workpiece includes at least two cylindrical surfaces and each of the surfaces is illuminated with a light source and provided with an electronic imaging camera.

3. The method of inspecting components of claim 1 wherein the workpiece is an engine crankshaft having at least four cylindrical surfaces and each of the surfaces is illuminated with a light source and provided with an electronic imaging camera.

4. The method of inspecting components of claim 1 further including the step of identifying the workpiece as unusable when the defect is determined to exist in the cylindrical surface.

5. The method of inspecting components of claim 4 wherein a size of the defect is approximately 0.05 mm. and greater.

6. The method of inspecting components of claim 1 further including the step of auto-correlating the sequence of images to eliminate image alignment errors.

7. A method of inspecting components having a cylindrical surface, comprising the steps of:
disposing a component having at least one cylindrical surface defining a center axis in a fixture for rotation about the center axis,
connecting a drive motor and rotation sensor to the component,
providing a light source to illuminate a portion of the cylindrical surface,
providing an electronic imaging camera,
synchronously rotating the component about the center axis and recording a plurality of adjacent images of the illuminated cylindrical surface provided by the electronic imaging camera, and
stitching together the recorded plurality of adjacent images provided by the electronic imaging camera to create a single planar view of the cylindrical surface.

8. The method of inspecting components having a cylindrical surface of claim 7 wherein the component is an engine crankshaft having at least four cylindrical surfaces and each of the surfaces has a dedicated electronic imaging camera providing a plurality of adjacent images.

9. The method of inspecting components having a cylindrical surface of claim 7 further including the step of determining whether a defect exists in the cylindrical surface of the component.

10. The method of inspecting components having a cylindrical surface of claim 9 wherein the defect has an approximate minimum size of 0.1 mm.

11. The method of inspecting components having a cylindrical surface of claim 7 wherein the illuminated portion of the cylindrical surface is facing the electronic imaging camera.

12. The method of inspecting components having a cylindrical surface of claim 7 further including the step of auto-correlating the plurality of images to eliminate image alignment errors.

13. The method of inspecting components having a cylindrical surface of claim 7 wherein the component is rotated 360°.

14. A method of detecting defects in a work piece having at least one cylindrical surface, comprising the steps of:
providing an electronic imaging camera,
illuminating a portion of the curved or cylindrical surface of the work piece,
rotating the work piece about its axis while the electronic imaging camera synchronously provides a plurality of adjacent individual longitudinal images representing discrete circumferentially adjacent regions of the cylindrical surface of the work piece,
recording the plurality of adjacent individual longitudinal images of the cylindrical surface of the work piece,
assembling the recorded discrete adjacent longitudinal images into a continuous, planar image, and
scanning the continuous, planar image for a surface irregularity.

15. The method of detecting defects of claim 14 wherein the work piece is an engine crankshaft having at least four cylindrical surfaces and each of the surfaces has a dedicated electronic imaging camera providing a plurality of adjacent images.

16. The method of detecting defects of claim 14 further including the step of determining whether the scanned surface irregularity is of a magnitude sufficient to reject the work piece.

17. The method of detecting defects of claim 16 further including the step of rejecting the work piece if the scanned surface irregularity has a size of 0.1 mm. or greater.

18. The method of detecting defects of claim 14 further including the step of rotating the cylindrical surface of the work piece 360°.
